(19) United States
(12) Patent Application Publication
(10) Pub. No.: US 2014/0340690 A1
(43) Pub. Date: Nov. 20, 2014

(54) GUIDED OPTICAL ROUTER, FIBRE-OPTIC INTERFEROMETER INTEGRATING SUCH AN OPTICAL ROUTER AND METHOD OF GUIDED OPTICAL ROUTING

(71) Applicant: Herve Lefevre, Paris (FR)

(72) Inventor: Herve Lefevre, Paris (FR)

(73) Assignee: IXBLUE, Marly Le Roi (FR)

(21) Appl. No.: 14/372,310

(22) PCT Filed: Jan. 14, 2013
(86) PCT No.: PCT/FR2013/050085

§ 371 Date: Jul. 15, 2014

(30) Foreign Application Priority Data
Jan. 16, 2012 (FR) 1250413

(51) Int. Cl. G02B 6/28; G01C 19/66

(52) U.S. Cl. CPC G02B 6/28; G01C 19/661
USPC 356/483; 385/24; 385/14

(57) ABSTRACT

A bidirectional guided optical router includes an evanescent-field optical coupler having three input ports, three output ports, a first central waveguide, a second lateral waveguide and a third lateral waveguide and an evanescent-field-based optical coupling zone in which the first, second and third waveguides are disposed so as to allow evanescent-field-based coupling between the first central waveguide and either one of the lateral waveguides. The 3×3 optical coupler has a length L of between 3154×L_{eq} and 2×L_{eq} such that an optical beam coupled on the first input port having a power p and propagating on the first waveguide in the forward direction is distributed according to the following distribution: a first secondary beam having a power 90% of p/2 on the second output port, another secondary beam having a same power ≧90% of p/2 on the third output port.

The present invention relates to 50-50 guided bidirectional optical router for splitting an incident optical beam into two guided optical beams of same power in a direction of propagation and for combining two guided optical beams into an optical beam guided in the reverse direction of propagation. More precisely, the invention relates to an evanescent-field optical router of high thermal and spectral stability. The invention also relates to a fiber-optic gyroscope comprising such a guided optical router. The invention also relates to a method of low-loss reciprocal optical routing, in particular in a fiber-optic gyroscope application.

An optical splitter is commonly used to split an optical beam into two beams of same power, for example in an amplitude-splitting interferometer or in an optical router for telecommunication. A 50-50 optical splitter, also called −3 dB splitter, allows splitting an optical beam into two secondary beams of same power. In the reverse direction, a 50-50 optical splitter is also used to combine in amplitude two optical beams coming from two branches of an interferometer, as for example the two ends of a fiber-optic gyroscope. In most applications, it is essential that the optical splitter ensures a 50-50 distribution of the incident power, independently of the wavelength of the beams as well as the environment and in particular the temperature.

Different types of optical splitters are known, such as a semi-reflective plate in conventional optics, a Y-junction in fiber optics or in integrated optics, or an evanescent-field coupler with two times two ports (i.e. two input ports and two output ports or 2×2 coupler) in fiber optics or in integrated optics. The properties of the different known beam splitters/combiners and especially the 50-50 splitters will be reviewed.

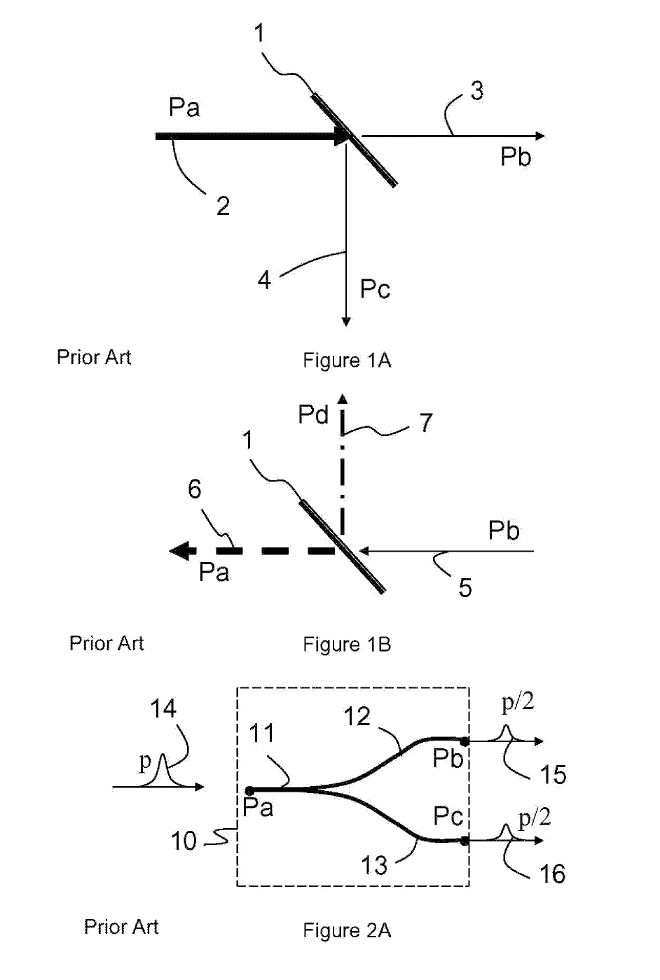

In conventional optics, a semi-reflective plate allows to spatially split an incident optical beam into two optical beams each having 50% of the power of the incident beam. FIG. 1A schematically shows a semi-transparent plate in conventional optics. The plate 1 receives at a port Pa an incident beam 2. The semi-reflective plate 1 splits the incident beam 2 into a first secondary beam 3 at a port Pb and a second secondary beam 4 at a port Pc. By energy conservation, all the power of the beam 2 is distributed between the beam 3 and the beam 4. Advantageously, the plate 1 is selected in such a way that the secondary beams 3 and 4 have the same power. FIG. 1B shows the same semi-transparent plate 1, operating in the reverse direction. The plate 1 receives at port Pb a beam 5. The plate 1 slits the beam 5 into a first secondary beam 6 at port Pa and a second secondary beam 7 at a fourth port Pd. By energy conservation, all the power of the beam 5 is distributed between the beam 6 and the beam 7. By reciprocity, the power that goes from port Pa to port Pb in FIG. 1A is identical to the power that goes from port Pb to port Pa in FIG. 1B. It is easily understood that the semi-transparent plate operates similarly whatever the input port on which a light beam is incident. The semi-reflective plate 1 thus constitutes a four-port optical router, more precisely an optical router with two input ports and two output ports.

The function of 50-50 beam power splitting may also be performed in guided optics, through an integrated optical circuit (IOC) or through a fiber-optic component.

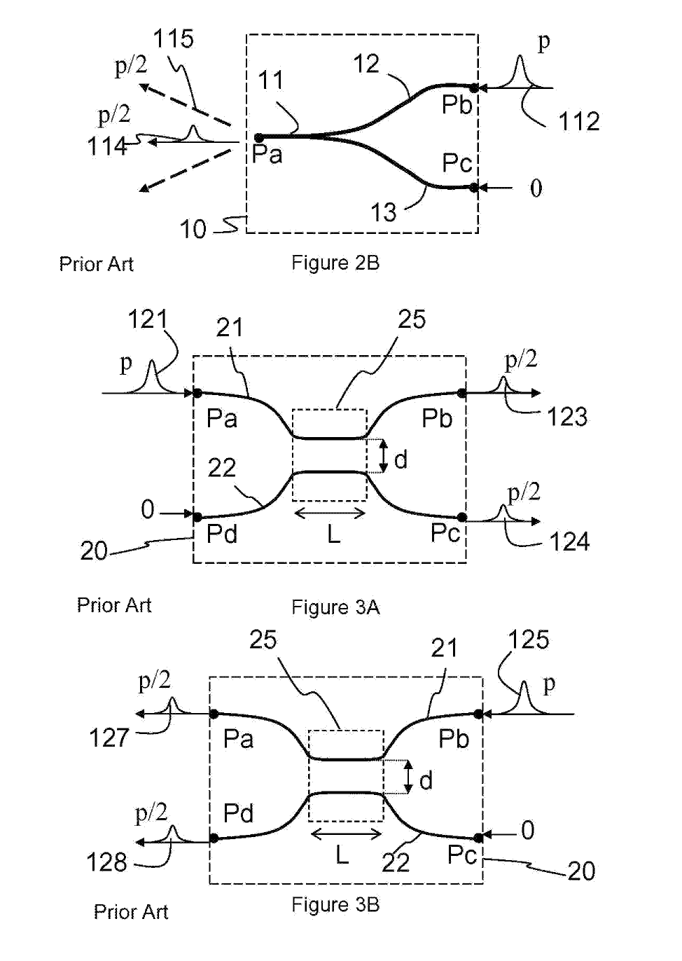

An amplitude-splitting integrated optical circuit is known, for example, which comprises a single-mode waveguide in the form of a Y-junction (cf. FIG. 2A). The junction 10 comprises a common branch 11 connected to a first secondary branch 12 and to a second secondary branch 13. An integrated optical circuit being manufactured by techniques of microlithography, a Y-shaped junction 10 on an integrated optical circuit is perfectly symmetric. A single-mode optical beam 14 of power p incident on port Pa propagates on the common branch 11 of the single-mode waveguide. The Y-junction splits the single-mode optical beam 14 into two single-mode secondary beams 15 and 16 propagating on the secondary branches 12 and 13, respectively, of the single-mode waveguide. By symmetry, each secondary beam 15, 16 receives 50% of the power of the incident beam 14. It is hence collected a power p/2 at port Pb and a power p/2 at port Pc. FIG. 2B shows the Y-junction of FIG. 2A operating in the reverse direction of propagation. A beam 112 of power p is coupled at port Pb, whereas there is a null power at port Pc. The Y-junction transmits a guided optical beam 114 on the common branch. However, the waveguide being single-mode, only one mode is guided on the common branch 11 of the Y-junction. By energy conservation, all the power of the beam 112 is distributed between a guided beam 114 and a non-guided beam 115. By reciprocity, the power that goes from port Pa to port Pb in FIG. 2A is identical to the power that goes from port Pb to port Pa in FIG. 2B. The guided optical beam 114 has a power equals to half (p/2) of the power of the incident beam 112. It is known that an anti-symmetric mode 115 of power equal to p/2 propagates in a non-guided manner in the substrate (Arditty et al., “Reciprocity properties of a branching waveguide”, Fibre-Optic Rotation Sensors, Springer series in optical sciences, Vol. 32, 1982, pp. 102-110). There thus exists a fourth non-guided port formed by this anti-symmetric mode of higher order. A part of this non-guided mode is liable to be collected by an optical fiber coupled to the common branch 11 of the waveguide. The signal detected at port Pa may hence be disturbed by the non-guided mode. The Y-junction is also a four-ports optical router, but with only three guided ports. Due to its symmetry, a Y-junction is stable in wavelength and in temperature.

In FIGS. 3A and 3B, another type of 50-50 optical router has been shown, which is based on the principle of evanescent-field optical coupling. The evanescent-field coupling consists in bringing together the cores of two single-mode waveguides 21, 22 in a zone of interaction 25 of length L along a longitudinal direction parallel to the axis of the waveguides 21, 22. The distance d between the centres of the two waveguides in the zone of interaction 25 is such that the fundamental mode propagating in the core of a single-mode waveguide is coupled by overlapping of the evanescent wave in the adjacent single-mode waveguide. In FIG. 3A, in the forward direction, a guided single-mode beam 121 of power p is coupled at port Pa, whereas there is a null power at port Pd. By evanescent coupling, the coupler 20 splits the beam 121 into a first guided single-mode secondary beam 123 at port Pb and a second guided single-mode secondary beam 124 at port Pc. In order to ensure a 50-50 split, the length of interaction of the zone of coupling is generally adjusted in such a way that half the power of the incident beam is distributed on each of the two output waveguides, the power at port Pb being equal to p/2, like the power at port Pc. FIG. 3B shows the same evanescent-field coupler 20 as in FIG. 3A, now operating in the direction opposite to the forward direction of propagation. A guided single-mode beam 125 of power p is incident at port Pb. By energy conservation, all the power of the beam 125 is distributed between a first guided single-mode beam 127 of power p/2 at port Pa and a second guided single-mode beam 128 of power p/2 at port Pd. By reciprocity, the power that goes from port Pa to port Pb in FIG. 3A is identical to the power that goes from port Pb to port Pa in FIG. 3B. An evanescent-field 2×2 coupler is also a four-port optical router, with four guided ports. Compared to a Y-junction, an evanescent-field 2×2 coupler has thus the advantage that it guides the beams at four ports.

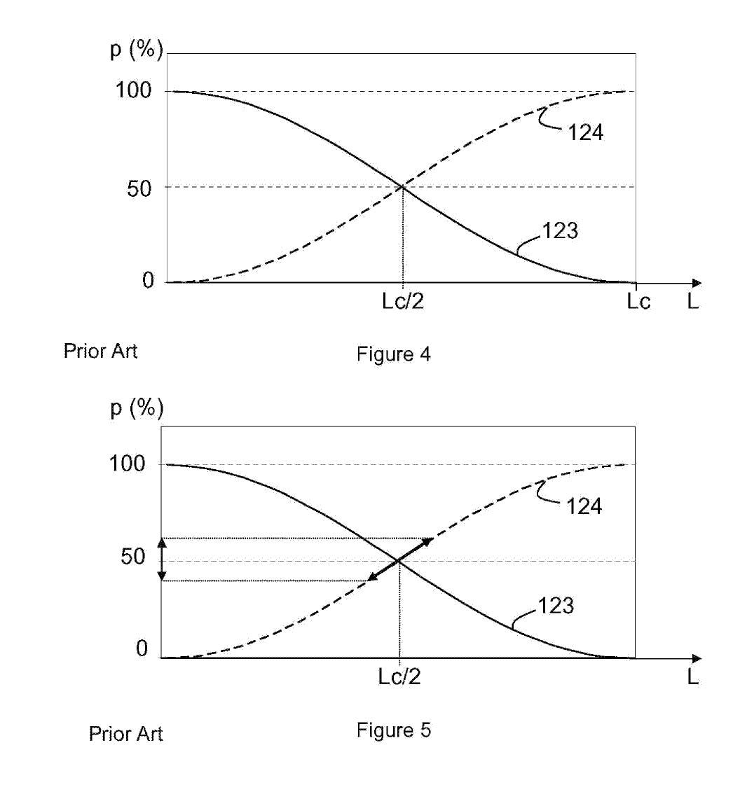

FIG. 4 shows the coupling curves of a 2×2 evanescent-field coupler as shown in FIG. 3A in the forward direction. The dash-line curve 124 represents the power coupled at port Pc as a function of the length L of the evanescent coupling zone 25. The solid-line curve 123 represents the remaining power at port Pb as a function of the length L. The power coupled from port Pa to port Pc (beam curve 124) follows a sin² law as a function of the length of interaction L. By energy conservation, the remaining power at port Pb (beam curve 123) follows a cos² law. After a length called coupling length, denoted Lc, the whole power of an incident optical beam injected at the first port Pa of the first waveguide 21 is entirely coupled in the second waveguide 22, which corresponds to the maximum of the coupling power curve 124 (cf. FIG. 3). For this length Lc, the power at port Pb is null.

In order to make an evanescent-field 2×2 and 50-50 coupler in guided optics or fiber optics, the length of interaction L of the evanescent coupling zone is adjusted to Lc/2, in such a way that half the incident power is transmitted at port Pb and the other half is coupled at port Pc. FIG. 5 indicates the operating point at Lc/2 of an evanescent-field 2×2 and 50-50 coupler. It can be observed that this operating point corresponds to a maximum slope of the power curves 123 and 124. A variation of beam wavelength or of the surrounding conditions produces a variation of the coupling force, hence of Lc, which generates a high variation of the power transmitted at port Pb and coupled at port Pc. In particular, any disturbance induces a deviation with respect to the operating point at Lc/2, hence an imbalance between the power transmitted at port Pb and coupled at port Pc (schematically shown by an arrow in FIG. 5). Therefore, an evanescent-field 2×2 and 50-50 coupler has not a good stability, in particular in wavelength.

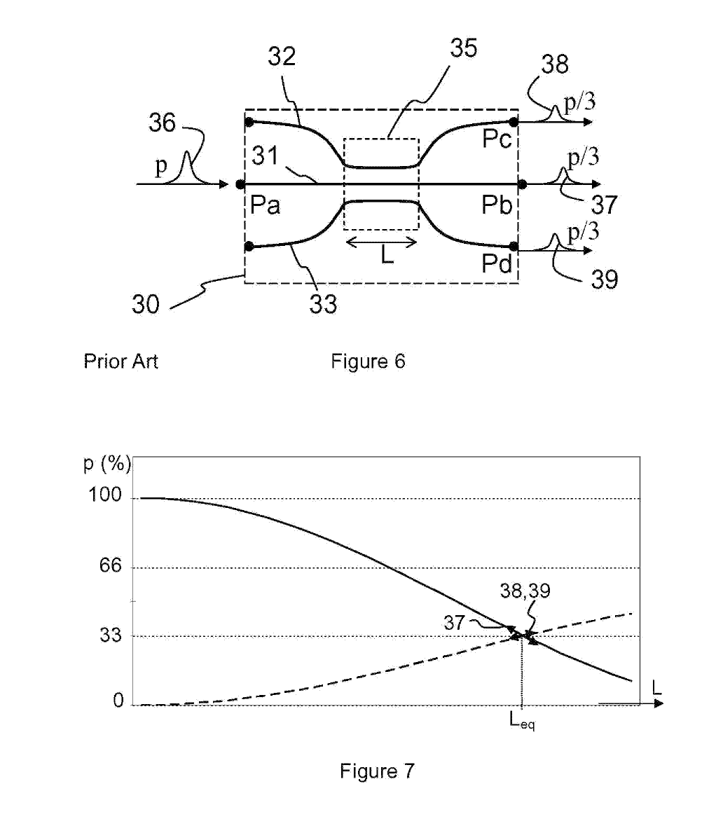

According to the same principle of evanescent-field coupling, an optical coupler 30 with three input ports and three output ports (or 3×3 coupler) on optical fibers is also known, in which the cores of three optical fibers are brought together by melting-drawing, in such a way that the cores of the three fibers extend parallel to each other in a same cladding over a coupling zone 35 (cf. FIG. 6). An evanescent-field 3×3 optical coupler 30 is generally adjusted (during the melting-drawing, the distance between the fibers decreases simultaneously with the increase of the length of interaction), so that a beam 36 of power p entering at an input port Pa is equidistributed into three beams 37, 38, 39 having an identical power (respectively, p/3, p/3, p/3) at each of the three output ports Pb, Pc, Pd. FIG. 7 shows the coupling curves of a ⅓-⅓-⅓ router. For a length L of the evanescent coupling zone equal to L_{eq}, the power at port Pb is equal to the power at ports Pc and Pd, and equal to one third of the incident power at port Pa. However, as in the case of a 2×2 coupler, the operating point at ⅓ in the coupling curves corresponds to a high slope. This operating point is hence sensitive to variations of wavelength and/or of temperature. A ⅓-⅓-⅓ equidistributed router is hence not much stable, in particular in wavelength.

A planar integrated optical circuit is also known, which comprises a 3×3 evanescent-field coupler comprising three parallel waveguides over an evanescent-field coupling zone 35. An input signal 36 of power p at port Pa of the central waveguide 31 is distributed in energy in a balanced manner over the three output ports Pb, Pc, Pd with a same power (respectively, p/3, p/3, p/3). These ⅓-⅓-⅓ 3×3 couplers have interesting phase-shift properties that make them useful in fiber-optic gyroscope applications (cf. S. K. Sheem “Fiber-Optic Gyroscope With [3×3] Directional Coupler” Applied Physics Letters, Vol. 37, 1980, pp. 869-871). The document U.S. Pat. No. 4,653,917 also describes a 3×3 evanescent-field coupler configured to split an incident beam into three beams of equal power.

The document P. Ganguly, J. C. Biswas, S. Das, S. K. Lahiri “A three waveguide polarization independent power splitter on lithium niobate substrate”, Optics Comm. 168 (1999) 349-354, describes a power splitter on an optical integrated circuit including an input single-mode waveguide and two output single-mode waveguides arranged on either side of the input waveguide in an evanescent-field coupling zone. The length L of the coupling zone is adapted to split an optical beam propagating in the central waveguide into two optical beams of same power propagating in the two output lateral waveguides. This power splitter operates similarly to a Y-junction.

To sum up, a Y-junction has the advantage that, due to its symmetry, it is stable in wavelength and in temperature, but has the drawback that it has a fourth non-guided port. A 2×2 evanescent-field coupler has the advantage that it guides all the ports, but has the drawback that it is not much stable, in particular in wavelength. An equidistributed (⅓, ⅓, ⅓) 3×3 coupler has the advantage that it guides all the ports, but has the drawback that it is not much stable, in particular in wavelength. Moreover, an equidistributed 3×3 coupler has the drawback that it induces a loss of one third of the input power.

One of the objects of the invention is to propose a 50-50 optical router that is stable in wavelength and all the input output ports of which are guided. Another object of the invention is to minimize the losses.

The present invention has for object to remedy the drawbacks of the prior arts and relates more particularly to a bidirectional guided optical router comprising a 3×3 evanescent-field optical coupler with three input ports, three output ports, a first central single-mode waveguide connecting the first input port and the first output port, a second lateral single-mode waveguide connecting the second input port and the second output port, and a third lateral single-mode waveguide connecting the third input port and the third output port, said optical coupler comprising a zone of evanescent-field optical coupling in which said first, second and third waveguides are arranged parallel to each other, said second and third lateral waveguides being arranged symmetrically with respect to the first central waveguide, and the distance between, on the one hand, the first central waveguide and any one of the second and third lateral waveguides being lower than a predetermined distance to allow an evanescent-field coupling between the first central waveguide and any one of the second and third lateral waveguides in the optical coupling zone.

According to the invention, the evanescent-field optical coupling zone of the 3×3 evanescent-field optical coupler has a coupling length L comprised between 1.3154×L_{eq} and 2×L_{eq}, where L_{eq} represents the length of equidistributed-power coupling for a reference evanescent-field optical coupler with three input ports and three output ports, having the same distances between waveguides and in the same conditions of beam wavelengths and of temperature, in such a way that, for said coupling length L (comprised between 1.3154×L_{eq} and 2×L_{eq}), an optical beam coupled at the first input port having a power p and propagating in the first central waveguide in the forward direction is split into a first secondary beam having a power higher than or equal to 90% of p/2 at the second output port and another secondary beam having a power higher than or equal to 90% of p/2 at the third output port, and said first, second and third waveguides go away from each other outside the optical coupling zone between each of the input ports and the optical coupling zone and, respectively, between the optical coupling zone and each of the output ports, said first, second and third waveguides being adapted to collect and guide in separated waveguides optical beams in symmetric mode and anti-symmetric mode propagating in the forward direction between the optical coupling zone and each of the output ports and, respectively, to collect and guide in separated waveguides optical beams in symmetric mode and anti-symmetric mode propagating in the reverse direction between the optical coupling zone and each of the output ports.

Each of said three input ports and three output ports are hence connected respectively to a distinct optical waveguide able to guide an optical beam from said input port, or respectively from said output port, towards the evanescent-field coupling zone, and reciprocally to guide an optical beam coming from the coupling zone towards said input port, or respectively said output port.

A reference 3×3 evanescent-field coupler is said of equidistributed output power when an incident beam of power p at the input port Pa of the equidistributed coupler is split into three secondary beams of same power p/3 at the three output ports Pb, Pc and Pd, respectively.

According to a particular embodiment, the evanescent-field optical coupling zone of the 3×3 evanescent-field optical coupler has a coupling length L comprised between 1.55×L_{eq} and 1.74×L_{eq}, in such a way that, for said coupling length L, an optical beam coupled at the first input port having a power p and propagating in the first central waveguide in the forward direction is split into a first secondary beam having a power higher than or equal to 99% of p/2 at the second output port and another secondary beam having a same power higher than or equal to 99% of p/2 at the third output port.

According to a particularly advantageous aspect of the invention, the coupling length L is equal to 1.6443×L_{eq}.

According to a preferred embodiment of the invention, said guided optical router comprises an integrated optical circuit on a planar substrate, said first, second and third waveguides extending in a plane parallel to said planar substrate, the first central waveguide being located at equidistance from the second and the third lateral waveguides in the evanescent-field optical coupling zone.

According to another embodiment of the invention, said first, second and third waveguides are fiber-optic waveguides, said evanescent-field optical coupling zone being a zone of melting-drawing of said first, second and third waveguide, said first, second and third waveguides being located mutually at equidistance from each other in the evanescent-field optical coupling zone.

The invention also proposes a fiber-optic Sagnac ring interferometer comprising a guided optical router according to one of embodiments described, and comprising a light source and a fiber-optic coil having two ends, said light source of wavelength X being optically coupled to the first input port of the guided optical router and wherein each of the two ends of the coil of the fiber-optic interferometer is coupled, respectively, to one of the second and third output ports of the guided optical router.

According to a preferred embodiment, the Sagnac ring interferometer further includes a second guided optical router according to one of the embodiments described, the second guided optical router being arranged in series between the source, the detector and the first guided optical router, the central waveguide of the first guided optical router being optically connected to the central waveguide of the second guided optical router.

Advantageously, at least one of the two secondary inputs of the first optical router is connected to optical detection means operable to detect at least one return secondary optical beam.

The invention also proposes a method of evanescent-field guided optical routing comprising the following steps:
sending a single-mode optical beam having a power p at the first input port of an optical router according to one of the embodiments described;
collecting a first secondary beam at the second output port of said guided optical router, said first secondary beam having a power higher than or equal to 90% of p/2;
collecting another secondary beam at the third output port of said guided optical router, said other secondary beam having a same power higher than or equal to 90% of p/2.

According to particular and advantageous aspects, the method of the invention comprises the following step(s):
detecting a signal representative of a secondary beam having a residual power at the first output port of said guided optical router;
modifying the length of interaction L in such a way to minimize said residual power of said secondary beam;
optically coupling said first secondary beam at a first end of a fiber-optic coil of a Sagnac ring interferometer in such a way that said first secondary beam travels through said fiber-optic coil along a forward direction of propagation;
optically coupling said other secondary beam at a second end of said fiber-optic coil of said Sagnac ring interferometer in such a way that said other secondary beam travels through said fiber-optic coil along a reverse direction of propagation;
detecting an interferometric signal at the first input port of said guided optical router;
guiding a return secondary optical beam of anti-symmetric mode in the second waveguide towards the second input port (Pe) and in the third waveguide towards the third input port (Pf) of said guided optical router.

The invention will find a particularly advantageous application in a fiber-optic Sagnac ring interferometer used in a fiber-optic gyroscope or as an electric current sensor or a Faraday-effect magnetic field sensor.

The present invention also relates to the characteristics that will be revealed by the following description and that will have to be considered in isolation or according to all their technically possible combinations.

The invention will be better understood and other objects, details, characteristics and advantages thereof will appear more clearly during the description of one or more particular embodiments of the invention given only by way of illustrative and non-limitative example, with reference to the appended drawings, in which:
FIGS. 1A-1B schematically show the operation of a separating plate in the forward direction (FIG. 1A) and in the opposite direction (FIG. 1B);

FIGS. 2A-2B schematically show a Y-junction splitter in the forward direction (FIG. 2A) and in the opposite direction (FIG. 2B);

FIGS. 3A-3B schematically show a 2×2 and 50-50 evanescent-field coupler according the prior art in the forward direction (FIG. 3A) and in the opposite direction (FIG. 3B);

FIG. 4 schematically shows coupling curves of a 2×2 evanescent-field coupler according to the prior art;

FIG. 5 shows the operating point of a 2×2 and 50-50 evanescent-field coupler;

FIG. 6 schematically shows a ⅓-⅓-⅓ equidistributed router with a 3×3 evanescent-field coupler according to the prior art;

FIG. 7 schematically shows the operating point of a ⅓-⅓-⅓ router with a 3×3 evanescent-field coupling;

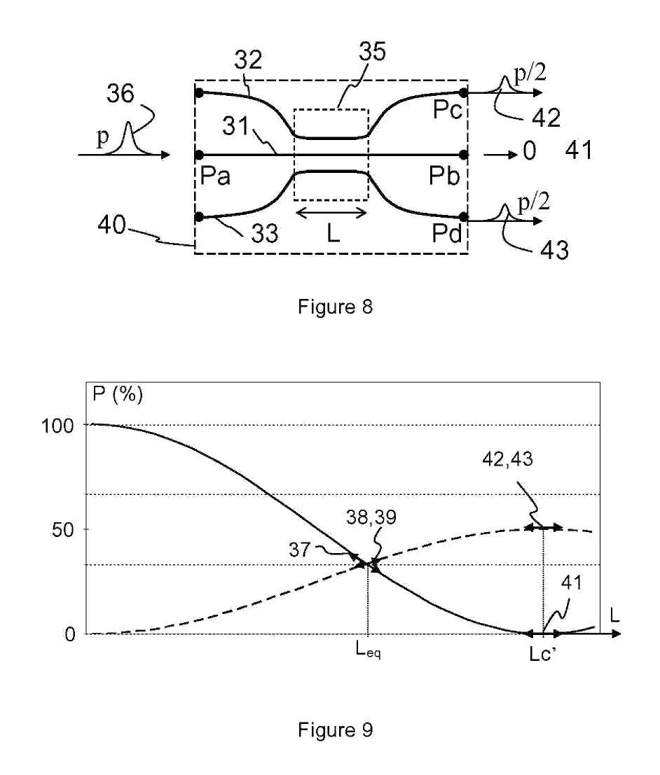

FIG. 8 shows a 50-50 router comprising a 3×3 evanescent-field coupler according to a preferred embodiment of the invention;

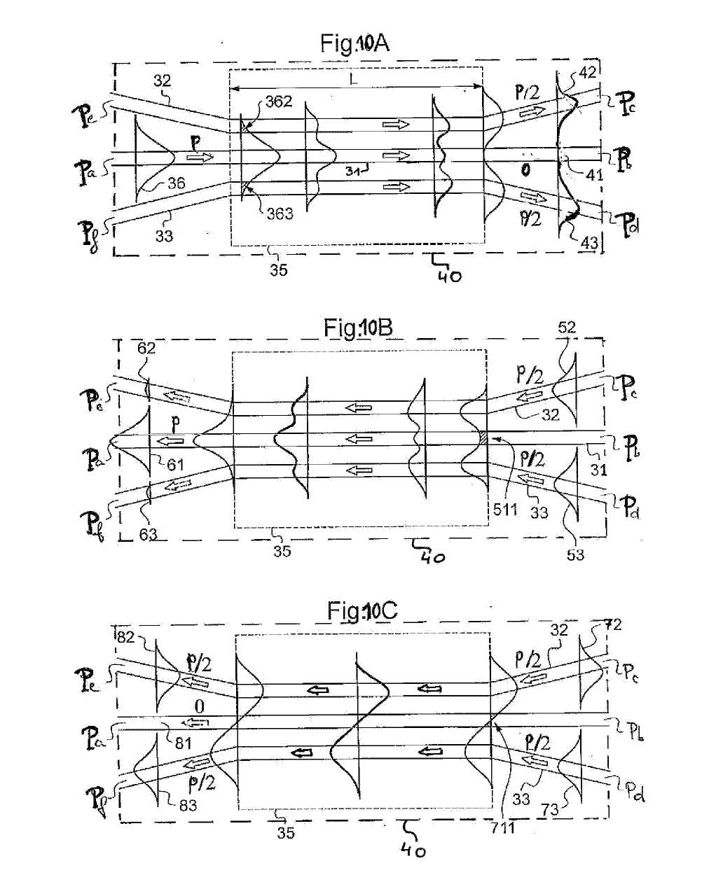

FIG. 9 schematically shows the coupling curves of the 50-50 router according to the invention;

FIGS. 10A, 10B, 100 and 10D schematically show the propagation of different beams in an optical router according to an embodiment of the invention;

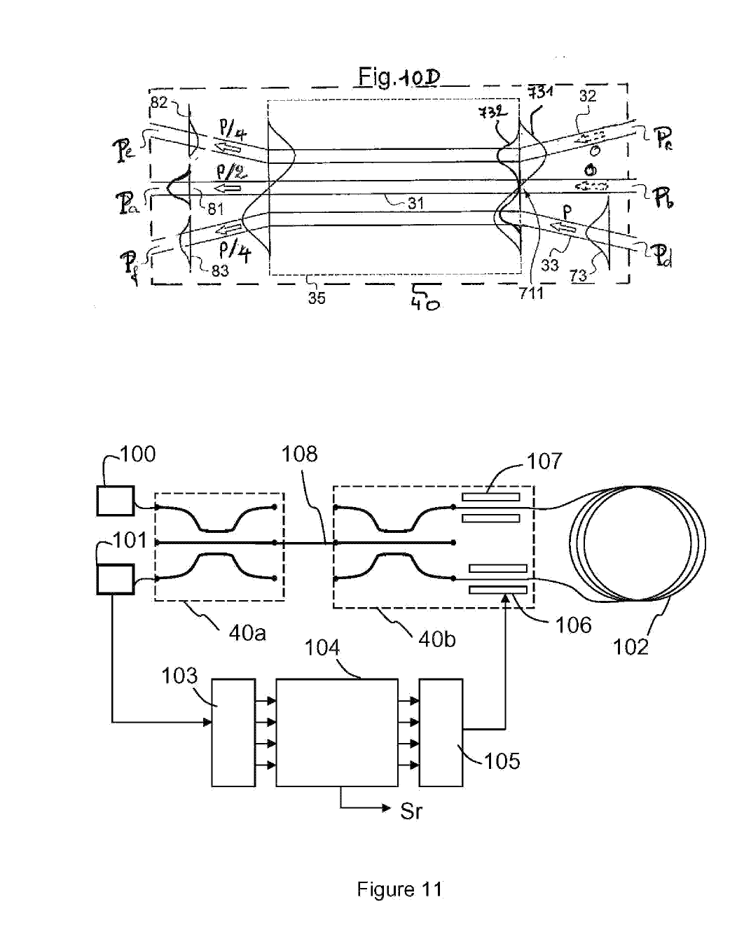

FIG. 11 schematically shows a fiber-optic gyroscope according to a preferred embodiment of the invention.

The invention is based on the use of a 3×3 evanescent-field coupler comprising three adjacent single-mode waveguides 31, 32, 33 over an evanescent-field coupling zone 35. However, this 3×3 evanescent-field coupler is configured differently from a coupler 30 of the prior art, as described in relation with FIG. 6.

The 3×3 evanescent-field coupler 40 of the invention is also configured differently from the power splitter-coupler described in the document P. Ganguly, J. C. Biswas, S. Das, S. K. Lahiri “A three waveguide polarization independent power splitter on lithium niobate substrate”, Optics Comm. 168 (1999) 349-354. In this document, the central single mode waveguide ends at one end of a coupling zone and the two lateral single-s mode waveguides end at the other end of the evanescent-field coupling zone. In the forward direction of propagation, this component operates as a Y-junction by splitting a guided beam propagating in the central waveguide into two guided beams propagating in the lateral waveguides. In the reverse direction of propagation, this component also operates as a Y-junction: two beams propagating respectively in the two lateral waveguides towards the coupling zone combine with each other to form a guided symmetric-mode beam in the central waveguide and an anti-symmetric-mode beam propagating in a non-guided manner in the substrate.

Firstly, an optical integrated circuit comprising the 50-50 optical router according to a first embodiment of the invention will be presented in relation with FIG. 8. The optical integrated circuit comprises a 3×3 coupler, comprising an evanescent-field coupling zone 35 in which three single-mode waveguides 31, 32, 33 are arranged preferentially parallel to each other. Two lateral waveguides 32, 33 are arranged symmetrically with respect to a central waveguide 31. The distance d between the central waveguide 31 and each of the lateral waveguides 32, 33 is preferably constant over the whole coupling zone 35, i.e. over a length L. The distance between the waveguides 31, 32, 33 and the length of the evanescent-field coupling zone 35 are determined and adjusted precisely to allow the operation of the optical coupler 40. In an embodiment, the waveguide is manufactured by proton exchange on a lithium niobate substrate, the wavelength of the incident beam is equal to 1530 nm, the length of interaction L is equal to 4 mm, the width of a waveguide is equal to 6 μm, the refractive index of the waveguide is equal to 2.15 and the distance d between the centre of the central waveguide 31 and the centre of any one of the lateral waveguides 32 or 33 is equal to about 14 μm.

The operation of the optical coupler 40 in a forward direction of propagation of an incident beam (from the left to the right in FIGS. 8 and 10A) will be first described, then the operation in the opposite direction of propagation (from the right to the left in FIG. 10B, 10C and 10D).

FIG. 10A shows the operation of the optical coupler 40 in the forward direction of propagation. In FIG. 10A, the evanescent coupling zone 35 of an optical coupler according to a preferred embodiment of the invention has been represented. Let's suppose that a single-mode optical beam 36 of power p is injected at the input port Pa of the central waveguide 31, whereas no optical beam is coupled at the input ports Pe and Pf of the two lateral waveguides 32, 33. At the input of the coupling zone 35, the incident beam exhibits a spatial distribution of power centred on the central waveguide 31, with a maximum in the central waveguide, and extends decreasing towards the lateral waveguides 32, 33. The distance d between the central guide 31 and the lateral guide 32, respectively 33, is such that the incident beam exhibits an energy overlap zone 362 in the lateral waveguide 32, and symmetrically an energy overlap zone 363 in the lateral waveguide 33. During its propagation in the coupling zone 35, the incident beam 36 is progressively coupled by overlapping and symmetrically in the two lateral waveguides 32, 33. The 3×3 coupler remains always symmetric for the lateral paths. After a length L of the coupling zone equal to Lc′, the spatial distribution of power of the beam exhibits two maxima centred respectively in each of the lateral waveguides 32, 33 and a minimum in the central waveguide 31. At this length Lc′, half the power of the incident beam 36 is transferred to a lateral waveguide 32 and the other half of the incident beam power is transferred to the other lateral waveguide 33. At the lateral output Pc, respectively Pd, of the coupler 40, a secondary beam 42, respectively 43, of power equal to p/2 propagates. The output secondary optical beams 42 and 43 are in phase with each other. At the central output Pb of the central waveguide 31, only one secondary beam 41 of almost-null residual power (ε<<1) propagates. It is hence obtained a 50-50 optical router or optical splitter that it perfectly power balanced between the port Pc and the port Pd due to the symmetry of this optical coupler.

The length L of the evanescent coupling zone 35 for a distance d between the waveguides of this zone 35 may be determined in practice by coupling an incident beam at the input Pa of the central guide and by measuring the intensity at the output Pb of this central waveguide. When the length L of the coupling zone of a 3×3 coupler is equal to a length L_{eq}, the incident power at the input port Pa is equidistributed into three thirds at the three output ports Pb, Pc and Pd. Indeed, the coupling curve at the ports Pc and Pd follows a law in (½ ×sin²(π/2×L/Lc′)). By energy conservation, the power curve transmitted to the port Pb follows a low in cos²(π/2×L/Lc′). According to the invention, the length L of the coupling zone 35 of an equidistributed 3×3 coupler is lengthened, while keeping the same distances between waveguides, and thus the same coupling force between adjacent waveguides. In identical conditions of wavelength and temperature, for a length L equal to Lc′, the power at port Pb is null, whereas the power coupled at port Pc and at port Pd is equal to p/2. In other words, when the intensity at the output Pb is null, it corresponds to the 50-50 splitting operating point between the two lateral outputs Pc and Pd. This configuration ensures a maximum coupling between the input port Pa and the two useful output ports Pc and Pd. The operating point of the 50-50 3×3 optical router corresponds to a value L equal to Lc′, such that ½ sin² ((π/2×Lc′/Lc′) is equal to ½ and cost (π/2×Lc′/Lc′) is equal to 0. Numerically, it is calculated that the length Lc′ is equal to L_{eq}×1.6443, where L_{eq} corresponds to the length of a 3×3 coupler of equidistributed power (⅓, ⅓, ⅓), this value being given by (π/2)×1/Arc cos(1/√3))=1.6443. The operating point of the 50-50 optical router of the invention is located at a maximum on the power distribution curve for the ports Pc and Pd and at a minimum for the port Pb. At theses minimum and maximum points of the coupling curves, the 50-50 router of the invention has a great stability both in wavelength and in temperature.

Advantageously according to the invention, the length L of the 50-50 optical router of the invention is comprised between such a length L that more than 90% of the power p/2 is transferred to the ports Pc and Pd of the lateral waveguides, which corresponds to a length L comprised between 0.8×Lc′ and 1.2×Lc′ or to a length L comprised between 1.3154×L_{eq} and 2×L_{eq}. In a high-performance variant, the length L of the 50-50 optical router of the invention is comprised between a length L such that more than 99% of the power p/2 is transferred to the ports Pc and Pd of the lateral waveguides, which corresponds to a length L comprised between 0.94×Lc′ and 1.06×Lc′ or to a length L comprised between 1.55×L_{eq} and 1.74×L_{eq}. As indicated hereinabove, the length Lc′ is equal to 1.6443 times the length L_{eq} of an equidistributed 3×3 coupler, which remains compatible with the length of an IOC substrate of 40 to 50 mm.

Outside the optical coupling zone 35, the first waveguide 31, the second waveguide 32 and the third waveguide 33 go away from each other between each of the input ports, respectively Pa, Pe, Pf, and the optical coupling zone 35. Likewise, the first waveguide 31, the second waveguide 32 and the third waveguide 33 go away from each other between the optical coupling zone 35 and each of the output ports, respectively Pb, Pc, Pd. The beams guided in the different waveguides 31, 32, 33 propagate in a guided and independent manner in each waveguide 31, 32, 33, outside the optical coupling zone 35.

Let's study now the operation of this 3×3 coupler in the reverse direction of propagation of light in FIGS. 10B-10D.

FIG. 10B shows the operation of the 50-50 router in symmetric mode, in the reverse direction of propagation of the beams. This operation is reciprocal with respect to the operation in the forward direction of FIG. 10A. Let's first suppose that a beam 52 of power p/2 is coupled at the output Pc of the second lateral waveguide 32 and that a beam 53 of same power p/2 is coupled at the output Pd of the third lateral waveguide 33, the two beams 52 and 53 being single-mode and in phase with each other (FIG. 10B). In the same time, no optical beam is coupled at the output Pb of the central waveguide 31. The two beams 52, 53 enter in the evanescent coupling zone 35. The beam 52 and the beam 53 are in phase with each other and each have an overlap zone with the central waveguide 31. The two overlap zones are superimposed in the central waveguide 31 to form an energy overlap zone 511. Due to the overlap with the central waveguide 31, these two beams 52, 53 in phase with each other are entirely coupled in the central waveguide 31 after a coupling length L equal to Lc′, i.e. at the other end of the evanescent coupling zone 35, where the waveguides 31, 32, 33 go away from each other. Hence, the whole power p of the two incident beams is found at the input port Pa of the central waveguide 31 (beam 61), whereas at each of the two input ports Pe, Pf of the lateral waveguides 32, 33, the power of the return secondary beams 62 and 63 is almost null (ε′<<1).

FIG. 10C shows the operation of the 50-50 router in anti-symmetric mode. Let's suppose now that a beam 72 of power p/2 is coupled at the output Pc of the second lateral waveguide 32 and a beam 73 of same power p/2 coupled at the output Pd of the third lateral waveguide 33, the two beams 72, 73 being single-mode and opposite in phase from each other (FIG. 10C). The two beams 72, 73 enter in the evanescent coupling zone 35. As above, the two beams 72, 73 partially overlap each other in the central waveguide 35. However, the two beams 72, 73 being opposite in phase from each other, the energy superimposition of the overlap zones cancels out in the central waveguide 31. There is then no coupling in the central waveguide 31. There is either no evanescent coupling between the lateral waveguides 32, 33, which are too far from each other in a planar integrated optical circuit. After propagation over the length L of the evanescent coupling zone 35, each lateral waveguide 32, respectively 33, transports a beam 82, respectively 83, keeping almost the same power as at the input of the evanescent coupling zone 35, the beams 82, 83 being in opposite phase with each other. Hence, there are a beam 82 having a power ˜p/2 at the input port Pe of the lateral waveguide 32, a beam 83 having a power ˜p/2 at the input port Pf of the other lateral waveguide 33, and a beam 81 of almost null power (<<1) at the input port Pa of the central waveguide 31. The anti-symmetric mode of the 3×3 router is hence 50-50 distributed between the input ports Pe and Pf of the lateral waveguides 32 and 33. The advantage of the thus-configured 3×3 coupler is that it allows to optically guide the anti-symmetric mode, which avoids disturbing the signal at the central port, unlike the case of the Y-junction.

FIG. 10D shows the operating mode of the 50-50 router in the reverse direction of propagation of the beams when only one beam 73 of power p is coupled at the output Pd of the third lateral waveguide 33 and thus when no power is coupled at the ports Pb and Pc, respectively, of the waveguides 31 and 32. The operating mode of FIG. 10D corresponds to the linear combination of the modes shown in FIG. 10B and FIG. 10C. The beam 73 may be decomposed into a symmetric mode 732 with two power lobes p/2 and centred on the waveguides 32 and 33 and an anti-symmetric mode 731, also of power p/2, on these same waveguides 32 and 33. The two-lobes symmetric and anti-symmetric modes are in phase with each other in the waveguide 33, where there is light, and in opposite phase with each other in the waveguide 32, where there is no light. After propagation through the coupling zone, the two-lobes symmetric mode 732 is completely coupled in the central waveguide, whereas the anti-symmetric mode 731 has stayed in the two lateral waveguides. It is therefore obtained at port Pa, a beam 81 of power equal to p/2, at port Pe a beam 82 of power equal to p/4 and at port Pf a beam 83 of power equal to p/4.

The 50-50 optical router of the invention has the advantage that it guides all the optical beams and has a great stability, in particular in wavelength.

According to a preferred embodiment of the invention, described in relation with FIGS. 8 and 10A-10D, the 50-50 router is manufactured on a planar integrated optical circuit.

According to another embodiment, a 50-50 optical router may be manufactured on an optical fiber by melting-drawing from three optical fibers. In a three-optical-fiber evanescent-field 3×3 coupler, the core of each of the three optical fibers is located at the apexes of an equilateral triangle.

An application of the 50-50 router of the invention relates to a fiber-optic Sagnac ring interferometer, used for example in a fiber-optic gyroscope. In FIG. 11 is schematically shown a fiber-optic gyroscope comprising two 50-50 routers based on 3×3 and 50-50 couplers, as described hereinabove. The gyroscope includes a fiber-optic coil 102, a light source 100, a detector 101, a first optical router 40a, an integrated optical circuit (IOC) including a second optical router 40b and a pair of integrated phase modulators 106, 107. The central waveguide of the first router 40a is optically connected by a single-mode optical fiber 108 to the central waveguide of the second optical router 40b. The gyroscope also includes an analog-digital converter 103, a numerical processor 104 and a digital-analog converter 105. The first optical router 40a operates as a beam splitter for separating the source 100 from the detector 101. As an alternative, instead of the first optical router 40a, a conventional beam splitter or an optical circulator may be used. The optical router 40b includes three waveguides and is configured so as to obtain a 50-50 energy distribution between the two lateral waveguides. Advantageously, the length L of the evanescent coupling zone 35 is comprised between 0.8×Lc′ and 1.2×Lc′, where Lc′ is the length of 50-50 lateral coupling as defined hereinabove. In other words, the length L of the evanescent coupling zone 35 is comprised between 1.3154×L_{eq} and 2×L_{eq}, where L_{eq} represents the length for a coupling of equidistributed power (⅓, ⅓, ⅓). The light source 100 emits an incident optical beam that is directed towards a first input of the optical router 40a. At the output of the optical router 40b, the energy distribution is controlled so that the power at the output port Pb is lower than 10% of the incident power. Still more advantageously, the power at the output port Pb lower than 1% of the incident power. When the power at the output port Pb of the first waveguide is minimised, it corresponds to the operating point at 50-50 of the optical router 40b. An end of the fiber-optic coil 102 is optically coupled to an output of the IOC 40b, the other end of the fiber-optic coil 102 is optically coupled to another output of the IOC 40b. Hence, a secondary beam having a power equal to p/2 propagates in the forward direction of the fiber-optic coil 102, and another secondary beam having a power equal to p/2 propagates in the reverse direction of the fiber-optic coil 102. At the input of the fiber-optic coil 102, the two secondary beams are in phase with each other. After propagation along the fiber-optic coil, respectively in the forward direction and in the reverse direction, the secondary beams undergo, by Sagnac effect, a relative phase-shift that is proportional to the rotational speed of the fiber-optic coil 102. Electrodes 106, 107 deposited on either side of the waveguides of the IOC 40b allow to modulate the phase of the optical beams to improve the processing of the signal. At the output of the coil 102, a first beam is collected in a lateral waveguide and a second beam in another waveguide of the IOC 40b. By reciprocity, the two beams at the output of the fiber-optic coil have the same power. The anti-symmetric reciprocal mode propagates in the central waveguide of the router 40b, then in the optical fiber 108 towards another router 40a (or splitter or circulator) and is coupled towards the detector 101. A converter 103 converts the analog signal of the detector into a numerical signal. After processing of the signal, a signal Sr is obtained, which is representative of a measurement of rotation of the fiber-optic coil 102. The processor calculates the modulation to be applied to the electrodes of the phase modulator 106, 107 via the converter 105. In a variant, secondary signals propagating at the ports Pe and Pf of the second optical router 40b may be measured. The gyroscope of FIG. 11 has the advantage that it allows a measurement of rotation while guiding the anti-symmetric reciprocal mode at another guided port.

The 50-50 guided optical router of the invention allows, by double lateral coupling, to split an incident single-mode optical beam into two single-mode optical beams of same power (i.e. −3 dB) in the forward direction. In the reverse direction of propagation of the beams, the optical router of the invention allows to combine two optical beams and to direct them without loss to form a symmetric mode guided towards a port and an anti-symmetric mode, also guided towards one or two other ports. The evanescent-field optical router has a great thermal and spectral stability and is easy to adjust.

The evanescent-field double-lateral coupling 50-50 router according to the invention has the advantage, compared to a Y-junction, that is allows to collect and guide the anti-symmetric mode. The router of the invention allows to avoid that the anti-symmetric mode disturbs the signal of the symmetric mode.

The 50-50 router of the invention hence combines the advantage of symmetry and stability associated with a Y-junction to that of guiding the whole of the ports of a 2×2 coupler.

1. A bidirectional guided optical router comprising an evanescent-field optical coupler having three input ports (Pa, Pe, Pf), three output ports (Pb, Pc, Pd), a first central single-mode waveguide (31) connecting the first input port (Pa) and the first output port (Pb), a second lateral single-mode waveguide (32) connecting the second input port (Pe) and the second output port (Pc), and a third lateral single-mode waveguide (33) connecting the third input port (Pf) and the third output port (Pd), said optical coupler comprising an evanescent-field optical coupling zone (35) in which said first, second and third waveguides (31, 32, 33) are arranged parallel to each other, said second and third lateral waveguides (32, 33) being arranged symmetrically with respect to the first central waveguide (31), and the distance d between, on the one hand, the first central waveguide (31) and any one of the second and third lateral waveguides being lower that a predetermined distance to allow an evanescent-field coupling between the first central waveguide (31) and any one of the second and third lateral waveguides (32, 33) in the optical coupling zone (35),
characterized in that:
the evanescent-field optical coupling zone (35) of the evanescent-field optical coupler has a coupling length L comprised between 1.3154×L_{eq} and 2×L_{eq}, where L_{eq} represents the length of equidistributed-power coupling for a reference evanescent-field optical coupler with three input ports and three output ports, having the same distances between waveguides and in the same conditions of beam wavelengths and of temperature, in such a way that, for said coupling length L, an optical beam (36) coupled at the first input port (Pa) having a power p and propagating in the first central waveguide (31) in the forward direction is split into a first secondary beam (42) having a power higher than or equal to 90% of p/2 at the second output port (Pc) and another secondary beam (43) having a power higher than or equal to 90% of p/2 at the third output port (Pd), and in that said first, second and third waveguides (31, 32, 33) go away from each other outside the optical coupling zone (35) between each of the input ports (Pa, Pe, Pf) and the optical coupling zone (35) and, respectively, between the optical coupling zone (35) and each of the output ports (Pb, Pc, Pd), said first, second and third waveguides (31, 32, 33) being adapted to collect and guide in separated waveguides (31, 32, 33) optical beams in symmetric mode and anti-symmetric mode propagating in the forward direction between the optical coupling zone (35) and each of the output ports (Pb, Pc, Pd) and, respectively, to collect and guide in separated waveguides (31, 32, 33) optical beams in symmetric mode and anti-symmetric mode propagating in the reverse direction between the optical coupling zone (35) and each of the output ports (Pa, Pe, Pf).

2. The guided optical router according to claim 1, wherein the evanescent-field optical coupling zone (35) of the evanescent-field optical coupler has a coupling length L comprised between 1.55×L_{eq} and 1.74×L_{eq} in such way that, for said coupling length L, an optical beam (36) coupled at the first input port (Pa) having a power p and propagating in the first central waveguide (31) in the forward direction is split into a first secondary beam (42) having a power higher than or equal to 99% of p/2 at the second output port (Pc) and another secondary beam (43) having a same power higher than or equal to 99% of p/2 at the third output port (Pd).

3. The guided optical router according to claim 1, comprising an integrated optical circuit on a planar substrate, said first, second and third waveguides (31, 32, 33) extending in a plane parallel to said planar substrate, the first central waveguide (31) being located at equidistance from the second and the third lateral waveguides (32, 33) in the evanescent-field optical coupling zone (35).

4. The guided optical router according to claim 1, wherein said first, second and third waveguides (31, 32, 33) are fiber-optic waveguides, said evanescent-field optical coupling zone (35) being a zone of melting-drawing of said first, second and third waveguide (31, 32, 33), said first, second and third waveguides (31, 32, 33) being located mutually at equidistance from each other in the evanescent-field optical coupling zone (35).

5. A fiber-optic Sagnac ring interferometer comprising a guided optical router (40b) according to claim 1 and comprising a light source (100), an fiber-optic coil (102) having two ends, said light source (100) of wavelength λ being optically coupled to the first input port (Pa) of the guided optical router and wherein each of the two ends of the coil of the fiber-optic interferometer (102) is coupled, respectively, to one of the second and third output ports (Pc, Pd) of the guided optical router (40b).

6. The Sagnac ring interferometer according to claim 5, further including a second guided optical router (40a), arranged in series between the source (100), the detector (101) and the first guided optical router (40b), the central waveguide of the first guided optical router (40b) being optically connected to the central waveguide of the second guided optical router (40a).

7. The Sagnac ring interferometer according to claim 5, wherein at least one of the two secondary inputs (Pe, Pf) of the first optical router (40b) is connected to optical detection means operable to detect at least one return secondary optical beam.

8. A method of evanescent-field guided optical routing comprising the following steps:
sending a single-mode optical beam (36) having a power p at the first input port (Pa) of an optical router according to claim 1;
collecting a first secondary beam (42) at the second output port (Pc) of said guided optical router, said first secondary beam having a power higher than or equal to 90% of p/2;
collecting another secondary beam (43) at the third output port (Pd) of said guided optical router, said other secondary beam (43) having a power higher than or equal to 90% of p/2.

9. The method of optical routing according to claim 8, comprising the following steps:
detecting a signal representative of a secondary beam (41) having a residual power at the first output port (Pb) of said guided optical router, and
modifying the length of interaction L in such a way to minimize said residual power of said secondary beam (41).

10. The method of optical routing according to claim 8, comprising the following steps:
optically coupling said first secondary beam (42) at a first end of a fiber-optic coil (102) of a Sagnac ring interferometer in such a way that said first secondary beam (42) travels through said fiber-optic coil (102) along a forward direction of propagation;
optically coupling said other secondary beam (43) at a second end of said fiber-optic coil (102) of said Sagnac ring interferometer in such a way that said other secondary beam (43) travels through said fiber-optic coil (102) along a reverse direction of propagation;
detecting an interferometric signal at the first input port (Pa) of said guided optical router (40b);
guiding a return secondary optical beam of anti-symmetric mode in the second waveguide (32) towards the second input port (Pe) and in the third waveguide (33) towards the third input port (Pf) of said guided optical router (40b).

11. The guided optical router according to claim 2 comprising an integrated optical circuit on a planar substrate, said first, second and third waveguides (31, 32, 33) extending in a plane parallel to said planar substrate, the first central waveguide (31) being located at equidistance from the second and the third lateral waveguides (32, 33) in the evanescent-field optical coupling zone (35).

12. The guided optical router according to claim 2, wherein said first, second and third waveguides (31, 32, 33) are fiber-optic waveguides, said evanescent-field optical coupling zone (35) being a zone of melting-drawing of said first, second and third waveguide (31, 32, 33), said first, second and third waveguides (31, 32, 33) being located mutually at equidistance from each other in the evanescent-field optical coupling zone (35).

13. A fiber-optic Sagnac ring interferometer comprising a guided optical router (40b) according to claim 2 and comprising a light source (100), an fiber-optic coil (102) having two ends, said light source (100) of wavelength X being optically coupled to the first input port (Pa) of the guided optical router and wherein each of the two ends of the coil of the fiber-optic interferometer (102) is coupled, respectively, to one of the second and third output ports (Pc, Pd) of the guided optical router (40b).

14. The Sagnac ring interferometer according to claim 6, wherein at least one of the two secondary inputs (Pe, Pf) of the first optical router (40b) is connected to optical detection means operable to detect at least one return secondary optical beam.

15. The method of optical routing according to claim 9, comprising the following steps:
optically coupling said first secondary beam (42) at a first end of a fiber-optic coil (102) of a Sagnac ring interferometer in such a way that said first secondary beam (42) travels through said fiber-optic coil (102) along a forward direction of propagation;
optically coupling said other secondary beam (43) at a second end of said fiber-optic coil (102) of said Sagnac ring interferometer in such a way that said other secondary beam (43) travels through said fiber-optic coil (102) along a reverse direction of propagation;
detecting an interferometric signal at the first input port (Pa) of said guided optical router (40b);
guiding a return secondary optical beam of anti-symmetric mode in the second waveguide (32) towards the second input port (Pe) and in the third waveguide (33) towards the third input port (Pf) of said guided optical router (40b).
